(19) United States
(12) Patent Application Publication
(10) Pub. No.: US 2009/0117998 A1
(43) Pub. Date: May 7, 2009

(54) METHODS AND APPARATUS FOR A PROMOTIONAL COUPON SYSTEM

(75) Inventors: John J. Hilbert, Torrance, CA (US); Eric James Meyerhofer, Pasadena, CA (US)

Correspondence Address: FITZPATRICK CELLA HARPER & SCINTO, 30 ROCKEFELLER PLAZA, NEW YORK, NY, 10112, US

(73) Assignee: FUTURELOGIC, INC., Glendale, CA (US)

(21) Appl. No.: 12/266,474

(22) Filed: Nov. 6, 2008

Related U.S. Application Data
(60) Provisional application No. 60/986,043, filed on Nov. 7, 2007.

(51) Int. Cl. A63F 13/00

(52) U.S. Cl. 463/25

(57) ABSTRACT

A system for communicating with many host systems in use at a gaming establishment and/or associated gaming establishments for the creation, issuance, distribution and redemption of coupons based on data gathered from one or more host systems, games, player activity or anonymous activity, and coupon data, among others where data is gathered in data packets and stored in a database. The system can provide promotions to all patrons of a gaming establishment, either through player tracking or anonymously.

### CROSS-REFERENCE TO RELATED APPLICATION(S)

The present application claims the benefit of U.S. Provisional Patent Application No. 60/986,043, filed Nov. 7, 2007, the contents of which are hereby incorporated by reference as if stated in full herein.

### BACKGROUND OF THE INVENTION

1. Field of the Invention

This invention generally relates to printers and printer connected hardware used in cash-less slot machines and gaming, and more specifically to hardware and software operating with and within this equipment to perform promotional ticket printing, promotional data basing and printer and printer connected hardware-based promotional ticket triggering.

2. Background

The gaming machine manufacturing industry provides a variety of gaming machines for the amusement of gambling players. An exemplary gaming machine is a slot machine. A slot machine is an electro-mechanical game wherein chance or the skill of a player determines the outcome of the game. Slot machines are usually found in casinos or other more informal gaming establishments.

The gaming machine manufacturers have provided cash-less enabled games to the market for the last five year, and there now exists a broad population of such games in the casino industry. Cash-less enabled games are so named due to the fact that they can conduct their player's financial exchange with a mixture of traditional paper and coin currency and vouchers redeemable for cash or game credits.

Two pieces of equipment included in a cash-less enabled game is a printer to produce the vouchers, and a bill acceptor that supports automatic reading of the vouchers. In a cash-less enabled gaming system, when a player cashes out, the game is signaled and depending on the size of the pay out, the game can either present coins in the traditional method of a slot machine, or the game can cause the printer which is installed in such a machine to produce a voucher containing the value of the pay out. The voucher may then either be redeemed for cash at the cashier's cage for currency, or it may be inserted into one of the casino's games' bill acceptor, at which point the network and server to which the game is connected will recognize the voucher as valid, redeem it and place the appropriate amount of playing credits on the game.

Over time, cash-less enabled games have found an increasing acceptance and use in the gaming industry with both the players, who enjoy the speed of play and ease of transporting their winnings around the casino, and the casinos who have realized significant labor savings in the form of reduced coin hopper reloads in the games, and an increase in revenue due to speed of play. The broad installation base of cash-less enabled games guarantees a wide installed base of networked games and their installed printers which may be used to print coupons and promotions for the captive player audiences.

### SUMMARY OF THE INVENTION

The present invention identifies methods and apparatus for communicating with various systems in use at a gaming establishment and/or associated gaming establishments for the creation, issuance, distribution and redemption of coupons based on data gathered from host systems, games, player activity or anonymous activity, and coupon data, among others where the data is gathered in data packets and stored in a database. The system can provide promotions to all patrons of a gaming establishment, either through player tracking or anonymously.

In one aspect of the invention, one or more host systems include Player Tracking Server, Coupon Server, Gaming Table System, Point-of-Sale System (POSS), Ticket In, Ticket Out Management System (TITOMS), Games Network Server, Accounting, Slot Floor System, and Others such as Lodging.

In another aspect of the invention, one or more host systems connect to a System Gateway Server.

In another aspect of the invention, one or more host systems use a common communication protocol to interface with one or more games and/or components within each game, such as a printer/encoder for signaling and data transmission, the protocols include TCP/IP, Ethernet, XML, SOAP, among others.

In another aspect of the invention, one or more data packets are transmitted to and from one or more host systems.

In another aspect of the invention, a data packet includes promotional coupon data, player activity data, game data, host system data, and others.

In another aspect of the invention, a data packet includes data from another data packet.

### BRIEF DESCRIPTION OF THE DRAWINGS

These and other features, aspects, and advantages of the present invention will become better understood with regard to the following description, accompanying drawings and appendix where:

FIG. 1 is an architectural diagram of an exemplary connection of host systems and one or more games used in a gaming establishment in accordance with an exemplary embodiment of the present invention;

FIG. 2 is a block diagram of data packets of host systems and games in accordance with an exemplary embodiment of the present invention;

FIG. 3 is a data flow diagram of data packets transmitted through host systems in accordance with an exemplary embodiment of the present invention;

FIG. 4 is another data flow diagram of data packets transmitted through host systems in accordance with an exemplary embodiment of the present invention;

FIG. 5 is a data flow diagram of previously received player activity packets being processed by a coupon server to generate a promotional coupon for a player in accordance with an exemplary embodiment of the present invention;

FIGS. 6a through 6d are block diagrams of various communication means in accordance with an exemplary embodiment of the present invention;

FIG. 7 is a block diagram of a host system in accordance with an exemplary embodiment of the present invention;

FIG. 8 is a block diagram of a printer/encoder in accordance with an exemplary embodiment of the present invention; and

APPENDIX A is a list of definitions of terms as used herein.

Identically labeled elements appearing in different ones of the figures refer to the same elements but may not be referenced in the description for all figures.

### DETAILED DESCRIPTION OF THE INVENTION

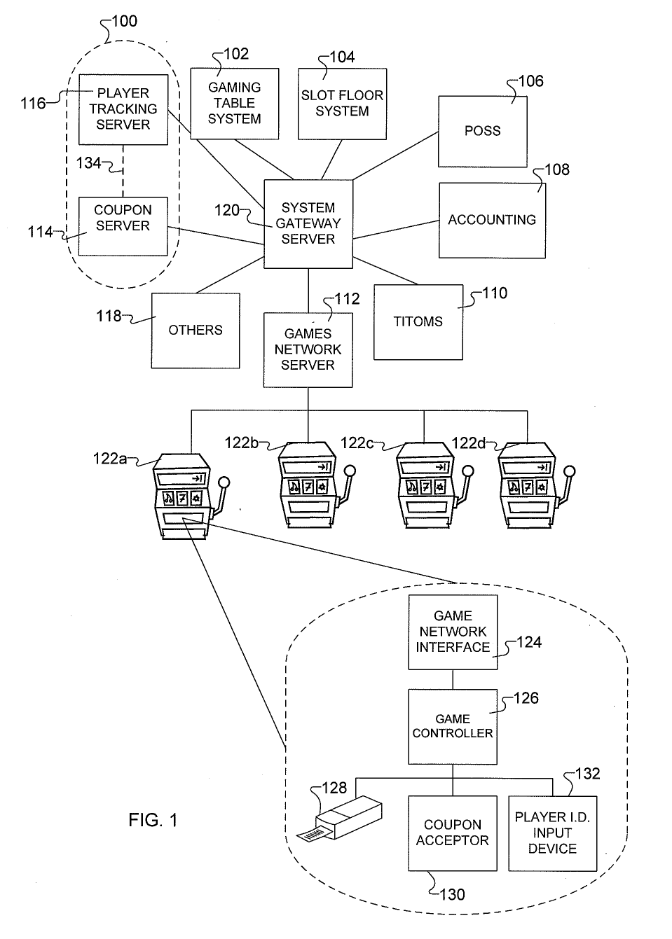

FIG. 1 is an architectural diagram of an exemplary connection of host systems and games used in a gaming establishment in accordance with an exemplary embodiment of the present invention.

Illustrated are host systems including: Gaming Table System 102, Slot Floor System 104, Point-of-Sale System (POSS) 106, Accounting 108, Ticket In, Ticket Out Management System (TITOMS) 110, Games Network Server 112, Coupon Server 114, Player Tracking Server 116, and Others 118 such as a Lodging System. Any system can be optional or combined with another system in use at a gaming establishment and/or associated gaming establishments; for example, the Player Tracking Server and Coupon Server are combined as a Promotional Couponing System 100.

These systems communicate with each other and other systems in use at a gaming establishment and/or associated gaming establishments for the creation, issuance, distribution and redemption of coupons based on data gathered from host systems, games, player activity or anonymous activity, and coupon data, among others where the data is gathered in data packets and stored in a database. The system can provide promotions to all patrons of a gaming establishment, either through player tracking or anonymously.

The Gaming Table System 102 manages and controls gaming tables.

The Slot Floor System 104 manages and controls games such as slot machines.

The POSS 106 manages and controls purchases made at points of sales.

The Accounting System 108 manages and controls financials of the gaming establishment and/or associated gaming establishment.

The TITOMS 110 manages and controls credits issued in games.

The Games Network Server 112 manages and controls games.

The Coupon Server 114 manages and controls the issuance and redemption of promotional coupons.

The Player Tracking Server 116 manages and controls player activity. The Player Tracking Server and Coupon Server can be connected 134 for signaling and data transmission.

Others 118 such as a Lodging System manage and control other activity.

Any or all host systems connect to a System Gateway Server 120 for signaling and data transmission.

The Games Network Server 112 connects to one or more games such as 122a, 122b, 122c, and 122d on the gaming establishment floor. One exemplary game is a slot machine. Another exemplary game is a gaming table such as a poker table.

Each game such as 122a includes a Game Network Interface 124 that interfaces with the Games Network Server 112. Each game also includes a Game Controller 126 that controls the game. The Game Controller connects to the Game Network Interface, a printer/encoder 128, coupon acceptor 130, and player I.D. input device 132, among others not shown.

The printer/encoder 128 prints and/or encodes one or more promotional coupons based on data transmission and signaling from one or more host systems such as a Promotional Couponing System 100. The coupons then are issued to the player. The printer/encoder also prints and/or encodes one or more game cashout vouchers based upon data transmission and signaling from the game and/or one or more host systems such as a Slot Floor System 104.

The coupon acceptor 130 permits the redemption of promotional coupons based on data transmission and signaling from one or more host systems such as a Promotional Couponing System 100.

The player I.D. input device 132 permits a player to enter or swipe their unique identification for tracking of that player's activities. Data regarding the player is transmitted to and from one or more host systems such as a Player Tracking Server 116. One example of a player I.D. input device is a keypad. Another example is a card reader.

Each game such as 122a also includes other components not illustrated.

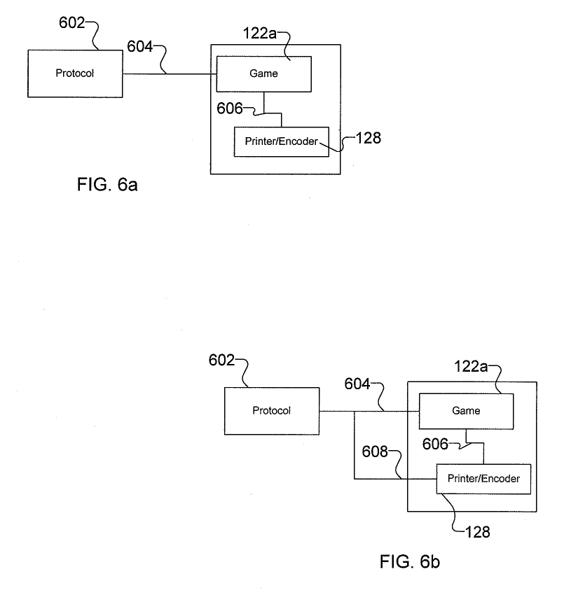

The host systems use a common communication protocol to interface with other host systems and one or more games such as 122a and/or components within each game, such as a printer/encoder 128 for signaling and data transmission. Example protocols include TCP/IP, Ethernet, XML, and SOAP, among others. Additional detail on the communication to the game or components thereof is later disclosed in FIGS. 6a through 6d.

In operation, data is transmitted to and from any system to the game or any component thereof for the creation, issuance and redemption of coupons. For example, data such as player ID from the Player Tracking Server 116 is used to personalize a promotional coupon. In another example, data such as game ID from the Slot Floor System 104 is used to identify which game the player is playing. In yet another example, data is pulled from various systems such as location from the POSS 106, player ID from the Player Tracking Server 116, and coupon information from the Coupon Server 114. This data is sent to the Accounting Server 108 for use with coupon redemption. In yet another example, data such as game ID from the Slot Floor System and player ID from the Player Tracking Server is pulled to generate a promotional coupon using the printer/encoder 128 of a game 122a.

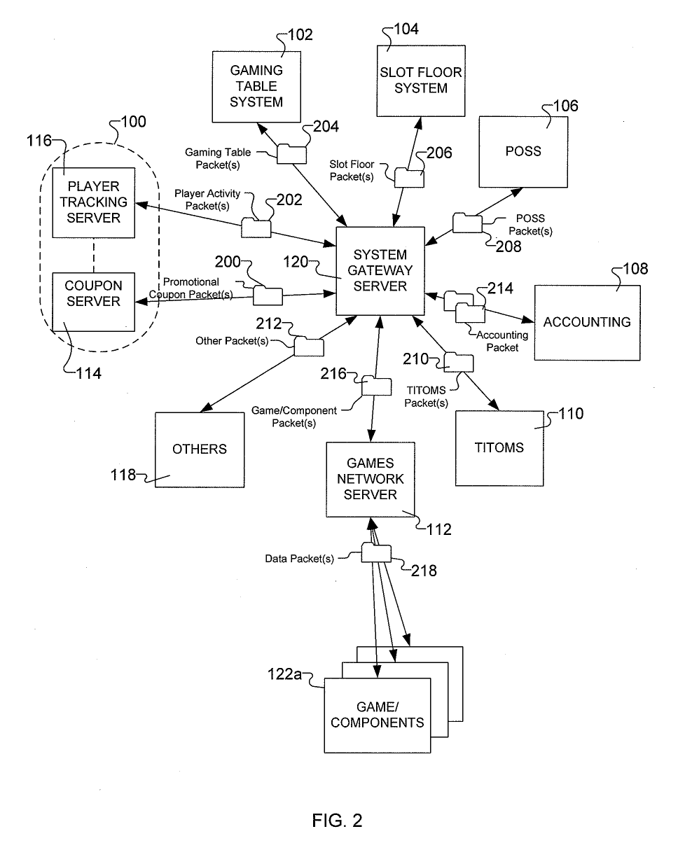

FIG. 2 is a block diagram of data packets of host systems and games in accordance with an exemplary embodiment of the present invention. Any system can be optional or combined with another system in use at a gaming establishment and/or associated gaming establishments; for example, the Player Tracking Server and Coupon Server are combined as a Promotional Couponing System 100.

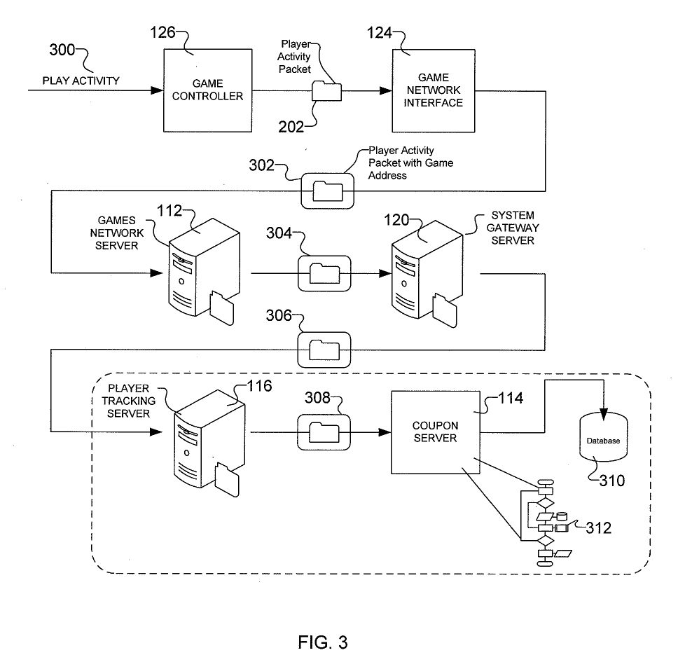

A data packet includes data information related to a host system, game, or component which is gathered and stored in a database 310 (of FIG. 3). Examples of data packets of a host system include a promotional coupon packet 200, player activity packet 202, gaming table packet 204, slot floor packet 206, POSS packet 208, TITOMS packet 210, Other packet 212, and accounting packet 214, among others. Examples of data packets of a game or component include game/component packet 216.

A promotional coupon packet 200 includes data such as a unique ID for the coupon, the promotion type, and date of issuance, among others from the Coupon Server 114. Many promotional coupon packets can be associated using a unique ID.

A player activity packet 202 includes data such as a player tracking system ID or an anonymous ID, among others from the Player Tracking Server 116. The ID is stored in one or more data packets such as a player activity packet which is transmitted to and from one or more host systems for data exchange. Many player activity packets can be associated using a unique ID such as the player tracking server identifier or anonymous identifier.

A gaming table packet 204 includes data from a gaming table such as gaming table ID, time and length of play, amount of winnings, among others from the Gaming Table System 102. Many gaming table packets can be associated using a unique ID.

A slot floor packet 206 includes data from the slot floor or any segment of a slot floor such as slot floor ID and segment ID, among others from the Slot Floor System 104. Many slot floor packets can be associated using a unique ID.

A POSS packet 208 includes data from the POSS 106 such as location ID, amount of purchase, and date of purchase, among others. Many POSS packets can be associated using a unique ID.

A TITOMS packet 210 includes data from the TITOMS 110 such as unique ID, amount of winnings, and amount of bet, among others. Many TITOMS packets can be associated using a unique ID.

A Other packet 212 includes data such as data related to a lodging system, among others from Others 118. Many other packets can be associated using a unique ID.

An accounting packet 214 includes data such a fund request ID, among others from Accounting 108. Many accounting packets can be associated using a unique ID. Additionally, any data packet is transmitted to and from the Accounting system.

A game/component packet 216 includes game and/or component data such as a game ID from a game such as game 122a, printer sub-address ID from a printer/encoder 128 (of FIG. 1), and coupon acceptor ID from a coupon acceptor 130 (of FIG. 1), among others from the Games Network Server 112. Many game/component packets may be associated using a unique ID.

One or more data packets can be combined for ease of data transmission. For example, the game/component data is combined with the coupon data in the promotional coupon packet 200. Additionally, one or more data packets is stored in a database 310 (of FIG. 3).

In another example, player activity packet 202 is combined with promotional coupon packet 200 data and transmitted from the Promotional Couponing System 100 to the System Gateway Server 120.

Data packets are transmitted to and from one or more host systems, for example, using the System Gateway Server 120. Additionally, data packets 218 are transmitted using the Games Network Server 112 to one or more games such as 122a and/or components of a game, such as a printer/encoder 128 (of FIG. 1) to generate one or more promotional coupons. Further, data packets are transmitted from the game and/or components of a game, such as a printer/encoder to notify one or more host systems that the coupon or coupons were generated.

FIG. 3 is a data flow diagram of data packets transmitted through host systems in accordance with an exemplary embodiment of the present invention.

As illustrated, play activity 300 is transmitted to the Game Controller 126 of a game. The data collected becomes a player activity packet 202, which is transmitted to the Game Network Interface 124. Additional data is collected from a game to form a game packet. In this illustration, the game packet is combined with the player activity packet 302.

The player activity packet with game address 302 is transmitted to the Games Network Server 112 where additional data such as server ID is collected from the server. All collected data is combined with the player activity packet 304 and transmitted to the System Gateway Server 120 where additional data is collected from the server.

All System Gateway Server 120 data is combined with the player activity packet 306 and transmitted to the Player Tracking Server 116 where additional data is collected from the server. All Player Tracking Server data is combined with the player activity packet 308 and transmitted to the Coupon Server 114 where the data packet is stored in a database 310. Algorithms 312 are used to process any or all of the data in the data packet.

In another embodiment, data collected from each server is stored in separate data packets.

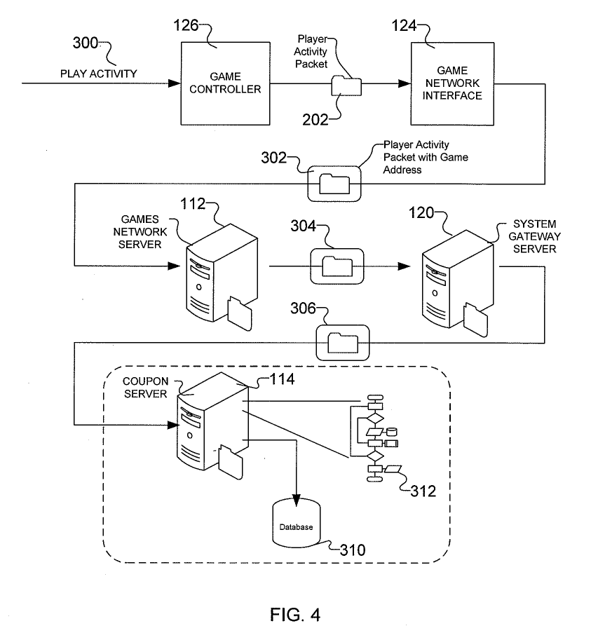

FIG. 4 is another data flow diagram of data packets transmitted through host systems in accordance with an exemplary embodiment of the present invention.

Play activity 300 is transmitted to the Game Controller 126 of the game where it becomes a player activity packet 202. This packet is transmitted to the Game Network Interface 124 where additional data is collected from the game to form a game packet. In this illustration, the game packet is combined with the player activity packet 302.

The player activity packet with game 302 address is transmitted to the Games Network Server 112 where additional data such as server ID is collected from the server. All collected data is combined with the player activity packet 304 and transmitted to the System Gateway Server 120 where additional data is collected from the server.

All System Gateway Server 120 data is combined with the player activity packet 306 and transmitted to the Coupon Server 114 where the data packet is stored in a database 310. Algorithms 312 are used to process any of the data in the data packet.

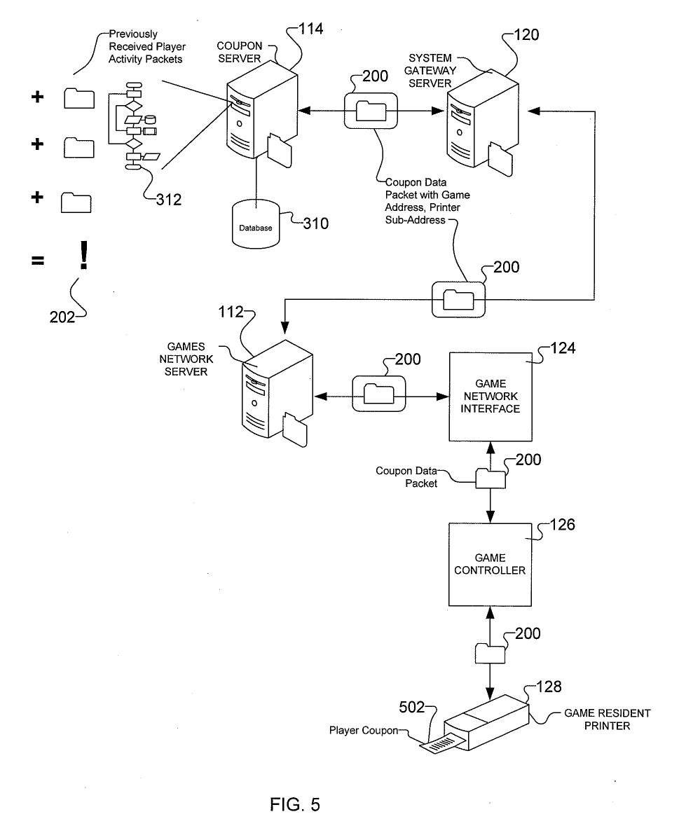

FIG. 5 is a data flow diagram of previously received player activity packets being processed by a coupon server to generate a promotional coupon for a player in accordance with an exemplary embodiment of the present invention.

One or more previously received player activity packets 202 is stored in a database 310. These packets are processed by the Coupon Server 114 using algorithms 312. The data is used to create a promotional coupon packet 200 which is transmitted to and from the various servers and components of the game such as Game Network Interface 124 and Game Controller 126.

The player activity packets 202 are transmitted from the game and components thereof to the Games Network Server 112 where, in turn, the packets are transmitted to the System Gateway Server 120. The packets then are transmitted to the Coupon Server 114 where they are stored in a database 310.

For the creation of a promotional coupon packet 200, data is collected such as previously disclosed in FIGS. 3 and 4. The data is stored in the database 310 and becomes a previously received player activity packet 202. These packets are processed by the Coupon Server 114 and transmitted to the System Gateway Server 120 where additional data can be collected. The packet is transmitted to the Games Network Server 112 where, for example, the server can use the game address and/or printer address within the packet to distribute the packet to the appropriate game.

The packet then is transmitted to the Game Network Interface 124 of the game where the packet is transmitted to the Game Controller 126 for processing by the printer 128 to produce a player coupon 502 using the data packet.

FIGS. 6a through 6d are block diagrams of various communication means in accordance with an exemplary embodiment of the present invention.

As previously disclosed in FIG. 1, the host systems use a common communication protocol 602 to interface with other host systems and more games and/or components within each game such as 122a, such as a printer/encoder 128 for signaling and data transmission. The protocols include TCP/IP, Ethernet, XML, and SOAP, among others.

In FIG. 6a, the communication means is protocol 602 communicating 604 with game such as 122a, and game communicating 606 with printer/encoder 128.

In FIG. 6b, the communication means is protocol 602 communicating 604 with game such as 122a; protocol communicating 608 with printer/encoder 128; and game communicating 606 with printer/encoder.

In FIG. 6c, the communication means is protocol 602 communicating 608 with printer 128; and game such as 122a communicating 606 with printer.

In FIG. 6d, the communication means is protocol 602 communicating 610 with controller 612, game such as 122a communicating 606 with printer/encoder 128, and printer/encoder communicating 614 with controller.

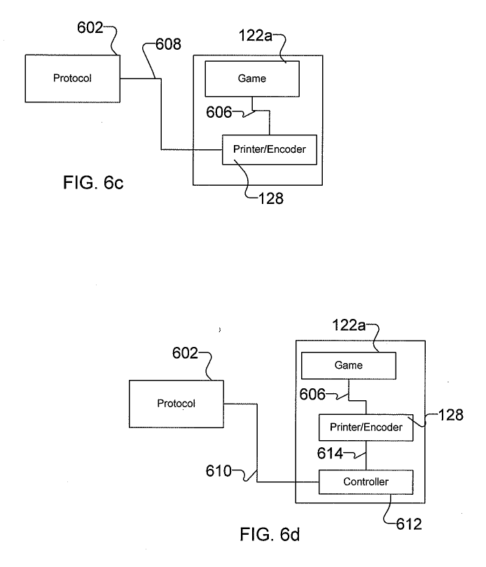

FIG. 7 is a block diagram of a host system in accordance with an exemplary embodiment of the present invention. Any component may be optional.

A host system 700 contains the programming instructions 702, memory 704, security interface means, among others necessary for signaling and data transfer for data verification and other purposes. Any exemplary host system is a Promotional Couponing System 100 (of FIG. 1) used to create, manage and track the issuance and redemption of promotional coupons.

A host includes a processor 706, operatively coupled via a bus 708 to a memory 704. The processor is further operatively coupled via the bus to a storage device 710. Program instructions 702 and data 712 for implementing the processes are stored in the storage device until the processor retrieves the program instructions and stores them in the memory. The processor then executes the program instructions stored in the memory and uses the data to implement the features of the processes described herein.

The processor 706 is further coupled via the bus 708 to one or more communications devices or ports 714. The host 700 uses the communications devices to securely transmit and receive control signals and/or data 712 to and from external devices as described herein such as a game 122a, printer/encoder 128, coupon acceptor 130 and player ID input device 132 (all of FIG. 1), among others.

The processor 706 is further coupled via the bus 708 to one or more user input devices 716 and one or more user output devices 718 for communicating with a user as described herein.

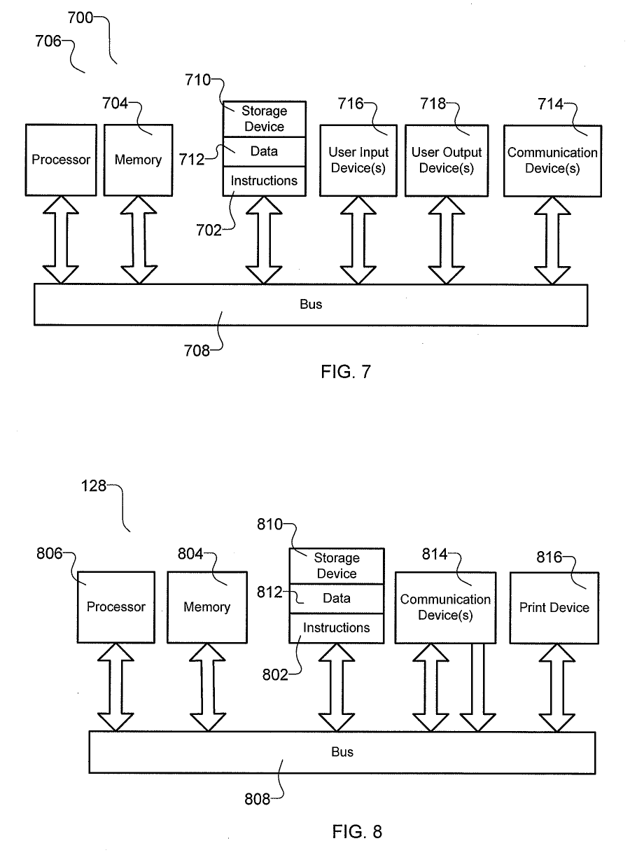

FIG. 8 is a block diagram of a printer/encoder in accordance with an exemplary embodiment of the present invention. Any component may be optional.

A printer/encoder 128 contains the programming instructions 802, memory 804, security interface means, among others necessary for signaling and data transfer of one or more files for data verification and other purposes.

A printer/encoder 128 includes a processor 806, operatively coupled via a bus 808 to a memory 804. The processor is further operatively coupled via the bus to a storage device 810. Program instructions 802 and data 812 implementing previously described processes are stored in the storage device until the processor retrieves the program instructions and stores them in the memory. The processor then executes the program instructions stored in the memory and uses the data to implement the features of the processes as described herein.

The processor 806 is further coupled via the bus 808 to one or more communication devices or ports 814. The printer uses the communication devices to securely transmit and receive control signals and/or data 812 to and from any external device such as a host system 700 (of FIG. 7), gaming system, and/or gaming machine, among others as previously described.

The processor 806 is further coupled via the system bus 808 to a print device 816. The printer/encoder 128 uses the print device to generate vouchers and/or coupons and to securely process data 812 such as a game/component data packet 216 (of FIG. 2) as previously described.

Although the invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by any claims supportable by this application and the claims' equivalents rather than the foregoing description.

### APPENDIX A—LIST OF TERMS

For the purposes of this document the following definitions apply:
“Gaming Establishment”—a gaming entity such as a casino.
“Associated Gaming Establishment”—a gaming entity in association with another gaming establishment.
“Gaming Machine”, “Game Machine”, “Game”—A slot machine, gaming machine, or game table in a gaming establishment.
“POSS”—acronym for Point-Of-Sale System. The system installed in a gaming establishment at various locations where business in the gaming establishment is transacted, such as a retail shop, restaurant, ticket sales counter, front desk, etc.
“TITOMS”—acronym for Ticket In, Ticket Out Management System. The system installed in a gaming establishment which issues game credits.
“Game Voucher” or “Game Cashout Voucher”—Media, such as paper or rewritable card, containing sufficient information to identify at a minimum, an amount of money and a validation number used to authenticate the transaction.
“Promotional Coupon”—Media, such as paper or rewritable card, containing sufficient information to identify at a minimum, a promotional event or a promotional reward to a player and validation information.
“Host System”—A computer, back-end system, gaming system, network, or other system that sends and/or receives information to and/or from a printer or other component in a cashless enabled game or gaming table. Examples of a host system include a wagering issuance and redemption system, a player tracking system, and a promotional couponing system, among others.

What is claimed is:

1. A promotional couponing system comprising:
gathering data from one or more host systems;
storing data from each host system in a data packet;
adding additional data from another host system to a data packet;
storing one or more data packets in a database; and
using one or more data packets to generate and issue a promotional coupon to a patron.
